(19) United States
(12) Patent Application Publication
(10) Pub. No.: US 2004/0045756 A1
(43) Pub. Date: Mar. 11, 2004

(54) Safety protectors for motorcycle exhaust pipes

(76) Inventor: James Martin, Hypoluxo, FL (US)

Correspondence Address: James Martin, 112 Lucina Drive, Hypoluxo, FL, 33462, US

(21) Appl. No.: 10/237,238

(22) Filed: Sep. 9, 2002

(51) Int. Cl. B62K 11/00

(52) U.S. Cl. 180/219

(57) ABSTRACT

Any existing material can be used as an insulator provided that it can withstand the heat of the exhaust pipe without melting and not transfer enough heat to the exterior barrier to cause a bare leg to be burned. The material must also be able to be cut or molded to a variety of shapes yet hold its finished shape. The material I used in my prototypes was high density polyethylene, commonly available at plastics suppliers, but other materials, such as bakelite, could be used. I used a one-half inch round aluminum rod as a barrier to the leg because a round rod was easier to shape to the line of the pipe, but a flat bar could be used. I retrofitted an existing, factory-installed chromed pipe shield to use as a barrier by installing the same insulating material between it and the exhaust pipe. No unusual or especially invented materials were used. My invention rests on the idea of an insulated barrier between the exhaust pipe and the leg, not on specific technical innovations of the materials to be used for that purpose.

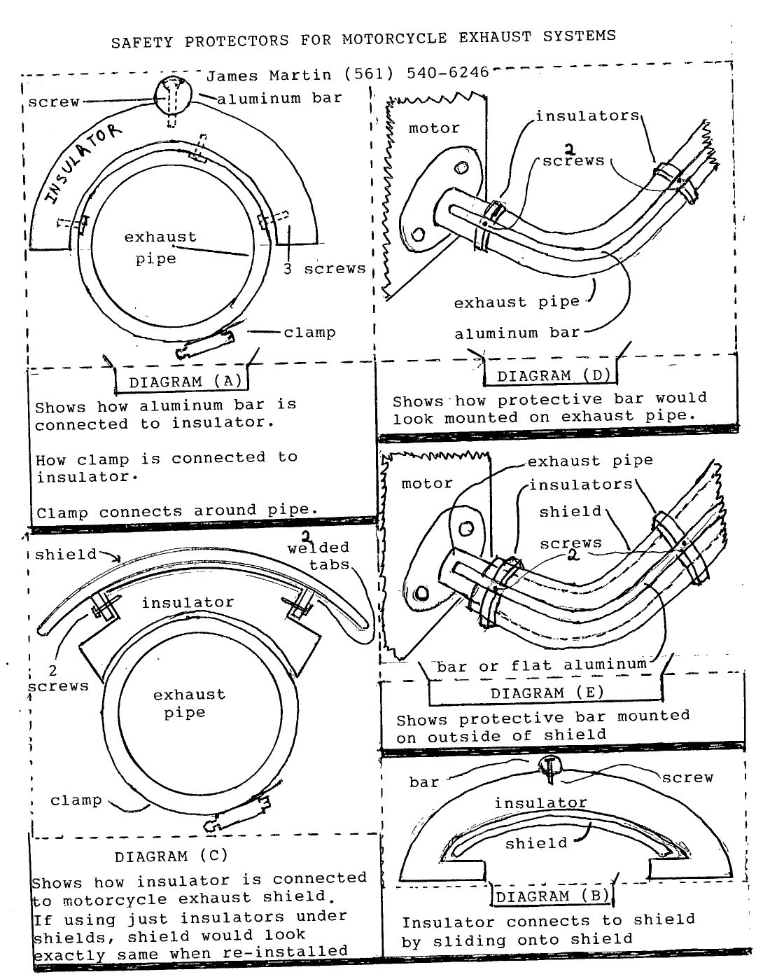

### CROSS-REFERENCE TO RELATED APPLICATIONS

Not Applicable

### STATEMENT REGARDING FEDERALLY SPONSORED RESEARCH

Not Applicable

### REFERENCE TO SEQUENCE LISTING . . . . DISK APPENDIX

Not Applicable

### BACKGROUND OF THE INVENTION

Motorcyclists have always been in danger of being burned by the hot exhaust pipes they must straddle. Until now, thick pants and boots have been their main protection. I am proposing a method of protecting and insulating the pipes themselves, which will give motorcyclists protection from burns without the need for protective clothing. In my forty years of riding motorcycles, I have never seen a motorcycle equipped with this kind of safety device, until 1 equipped my own.

### BRIEF SUMMARY OF THE INVENTION

I have devised ways to prevent leg burns by using insulators on the exhaust pipes One method uses an insulated barrier bar, or guard, between the leg and the hot pipe. The other method insulates a shield commonly supplied by the manufacturer so that it does not become hot enough to burn the leg.

### BRIEF DESCRIPTION OF THE SEVERAL VIEWS OF THE DRAWING

There are five diagrams on the “Drawing” page. Each diagram shows a different way to mount an insulated guard on the exhaust according to the preference of the owner and the type of exhaust pipes on the motorcycle.

Diagrams A and D show how to mount the leg guard on an exhaust pipe without a decorative shield.

Diagrams B and E show how to mount the leg guard on an exhaust pipe that is equipped with a decorative shield.

Diagram C shows how to insulate a decorative pipe shield so that it does not become hot enough to burn the leg.

### DETAILED DESCRIPTION of the INVENTION

Most motorcycles have exhaust pipes that get very hot. Many motor cycles are sold with chromed shields attached to the exhaust pipes. These are used to cover the discoloration of the pipes due to high heat. The problem is that these shields also get very hot. I have designed a device that can be attached to either a shielded or unshielded exhaust pipe and will prevent a rider's leg from touching the hot pipe.

My idea is to mount two or more insulators on the exhaust pipe and to connect them with a rigid bar which extends along the outside of the pipe where the rider's leg might touch it. I have designed a variation of this method to insulate a factory-installed pipe shield so that it stays cool.

Once an insulator is made for a particular motorcycle, it can be reproduced for all other motorcycles with the same size exhaust system.

There are three methods of installing these safety guards.

1. On exhaust pipes without shields:

The method is to attach a clamp to the inside of the insulator. The insulator I used was high-density polyethylene, one-half inch thick, which had been cut to the diameter of the pipe. If the pipe were closer to the motor and exposed to more heat, I might use an insulator 3/1′ thick. The clamp is an ordinary metal hose clamp, which is attached to the inside of the insulator with three small screws. The hose clamp is fastened around the exhaust pipe and holds the insulator to the pipe. Enough insulators (two should be sufficient) are attached to the pipe to support a rigid bar, which extends parallel to the pipe in the place where a rider's leg would ordinarily straddle it. This bar is attached to the outside of the insulator with a single screw. It is separated from the exhaust pipe by the thickness of the polyethylene, or one-half inch. This method is shown in Diagrams A and D on page 6.

2. On exhaust pipes with shields, using the rigid bar:

The same insulating material is cut in a shape that will slide between the shield and the pipe, and lock over the shield. At least two of these are needed. A rigid bar of the desired shape and size is attached to the outside of the insulators as described in method (1) above. No clamps are necessary to hold the insulators in place. This method is shown in Diagrams B and E on page 6.

3. On exhaust pipes with shields:

No rigid bar is necessary with this method. The existing shields are used to insulate the leg from the hot exhaust pipe. The shield and clamps are removed from the exhaust pipe and two tabs are welded on the inside of the shield. The insulating material (again, I used 1/2″ to 3/4′ high-density polyethylene) is cut to fit between the tabs. Screws are put through the tabs to hold the insulator in place. Then the original clamp is attached by screws to the inside of the insulator. Enough insulators (at least two) are attached to the shield to keep it approximately one-half inch from the exhaust pipe. The shield is then re-attached to the pipe in the same manner by which it was removed. This entire method is shown in Diagram C on page 6.

1. What I claim as my invention is a modification of motorcycle exhaust pipes which will prevent the motorcyclist from burning his legs on the hot pipes, by placing an insulator between the exhaust pipe and an outside barrier to the leg, which barrier may be a rod, slat, or decorative chromed shield.
